(19) United States
(12) Patent Application Publication
(10) Pub. No.: US 2004/0200149 A1
(43) Pub. Date: Oct. 14, 2004

(54) Door area monitoring device for monitoring the swing area of an automobile vehicle door

(76) Inventors: Juergen Dickmann, Ulm (DE); Moheb Mekhaiel, Neu-Ulm (DE); Michael Skutek, Ulm (DE)

Correspondence Address: Stephan A. Pendorf, Pendorf & Cutliff, 5111 Memorial Highway, Tampa, FL, 33634-7356, US

(21) Appl. No.: 10/779,454

(22) Filed: Feb. 13, 2004

(30) Foreign Application Priority Data
Apr. 11, 2003 (DE) 103 17 041.3

(51) Int. Cl. E05F 15/02

(52) U.S. Cl. 49/26; 49/27

(57) ABSTRACT

The invention concerns a door space monitoring device for monitoring a door swing area of a vehicle door.

The door space monitoring device is provided with a door swing space monitoring sensor means, with a sensor-data evaluating evaluation device, and with a control unit for controlling the sensor means or evaluation device. The sensor means includes a light source for emission of a pivotable light beam, a micro-mirror-unit and a photo-detector for sensing the two dimensional monitored area. Preferably the micro-mirror-unit is provided with at least one micro-mechanical pivotable planar mirror and an additional non-planar mirror. The door space monitoring device is characterized by a very compact and reliable functionality.

### BACKGROUND OF THE INVENTION

1. Field of Invention

The invention concerns a door area monitoring device for monitoring the swing area of an automobile door.

2. Related Art of the Invention

A device of this type is known from DE 101 17 516 A1. The device includes sensors which monitor the door swing area, an evaluation unit which evaluates the sensor data, and a control unit which controls of the components of the door area monitoring device. The sensors are radar sensors, which sense and monitor a difined area adjacent the vehicle doors. These sensors are typically micro-strip antennas, which are of considerable size.

DE 41 19 579 A1 discloses a device for detecting objects in obscured areas of a vehicle, using a contactless distance measuring device directed in the area outside the field of view (blind-spot), which works on the principle of ultrasound, infrared or radar. In the case of detection of an object approaching the vehicle door, that is, in the area monitored by the distance monitoring device, a door brake is activated. The distance measuring device is provided in the door. An analogous device is likewise known from U.S. Pat. No. 4,458,446 A1. Here, the distance to a potential collection object is determined by monitoring the delay time of reflected ultrasonic pulses.

German Patent DE 196 26 097 C1 discloses a system for displaying an image on a large screen projection surface by means of a digital micro-mirror device (DMD) projector having a DMD-chip. The DMD-chip is also referred to as a micro-mirror unit. The micro-mirror unit typically comprises a chip, upon the surface of which multiple thousand of small controllable micro-mirrors are provided. By changing the orientation of the individual mirrors an image is produced, which is projected through lenses onto the large screen projection surface. Each micro-mirror thus projects reflected incident light onto an image point of the large screen projection surface. Therein, by an appropriate control of the respective micro-mirror, it is ensured that a color mixture is produced as necessary for the representation of the individual image points. The color mixing is accomplished in that the respective micro-mirrors always project for an appropriate length of time a light beam upon the position of the projection surface, so long as the corresponding color beam is offered to it through the color filter. Therein the tipping or deflection of the micro-mirror is precisely directed to the target, and controlled both spatially as well as in length of time, that the image information to be depicted is transmitted precisely.

The present invention is concerned with the task, of providing a door area monitoring device according to the precharacterizing portion of patent claim 1, which is designed to be compact as well as to make possible a sufficiently reliable identification of interfering objects, which could result in a collision with the vehicle door.

This task is solved by a door area monitoring device with the characteristics of Patent claim 1.

Further advantageous embodiments of the invention are set forth in the dependent claims.

The inventive door area monitoring device includes sensors, which monitor or keep under surveillance a substantially planar or two-dimensional monitoring area, in that it includes at least one light source for emitting a light beam and at least one photo-receiver for surveying the two dimensional area being monitored, wherein the light beam emitted by the light source is deflected pivotably by at least one micro-mirror unit. By this pivotable deployment of the light beam in an essentially two dimensional monitoring area, it becomes possible to accomplish a reliable monitoring of the monitoring area in a simple manner. The two dimensional monitoring area is regularly scanned or pivoted together with the door, and paints or illuminates the relevant door swing area to the extent that an object which could come into contact with the door is reliably detected. By the use of a micro-mirror-unit it becomes possible to provide a very compact and flexible door area monitoring device which, due to the great flexibility of the micro-mirrors of the micro-mirror-unit which are precisely pivoted by the control unit, distinguishes itself as a simple, compact and standardized door area monitoring device. It is suitable for various vehicle doors without substantial hardware changes.

Besides the possibility of beaming multiple separate light beams into the area being monitored, in order to define the monitoring area it has proven itself reliable when one or a few light beams are pivoted in a scanning manner through the two-dimensional area being monitoring and thereby completely monitor the area being monitored and check for interfering obstacles. Therein the scanning design of the sensor means has proven itself to be particularly advantageous, since this design typically requires only a single light source. By the precise control of the micro-mirror-unit by the control unit, a very simple to adapt door area monitoring device is provided.

It has been found to be particularly useful to provide the micro-mirror-unit with at least one micro-mechanical pivotable planar mirror and additionally a further not planar mirror, and to associate these with the micro-mirror-unit. By the provision of the second, additional, non-planar mirror it becomes possible to provide a substantially flexible and compact sensor means for the inventive door area monitoring device which, as a result of the additional degree or axis of freedom of the non-planar mirror to the repeated deflection of the light beam of the light source, provides the possibility in a simple manner to monitor a number of two dimensional, and in particular non-planar, monitoring areas and to survey these for the presence of objects which represent a danger of collision. Therein it has been found particularly advantageous to design the contour of the non-planar mirror to correspond to the contour of the vehicle door. Thereby it becomes possible to translate the two dimensional non-planar contour of the vehicle door into a corresponding two dimensional, non-planar design of the monitoring area, and thereby to ascertain a reliable indicator regarding the danger of collision of the door with the obstacle. In particular, the possibility is provided by this contour-conforming design of the supplemental mirror, of having the monitoring area extend at a clearly defined distance from the door, wherein the distance over the surface area can be selected to be maintained substantially constant. Therein the distance is so selected that a reliable stopping of the door, in particular in the case of an automatic opening process for the door, is provided.

It has been found to be particularly advantageous to make the additional mirror pivotable. Thereby the possibility is achieved, to adapt the door area monitoring device very flexibly to changed spatial conditions. It has been found to be particularly advantageous to design the supplemental non-planar mirror to be driven micro-mechanically and to undertake the micro-mechanical actuation precisely by the control unit for the control of the micro-mirror-unit. By this common control it is ensured that a coordinated optimized and reliable control of the mirror is accomplished and thereby a reliable recognition of obstacles can be achieved.

It has been found to be particularly advantageous to provide the light source for emitting a light beam, the micro-mirror-unit and the photo-receiver for surveying the essentially two dimensional area being monitored on or in the external mirror, wherein the external mirror is directly connected to the door. Thereby it is ensured that the external mirror pivots together with the vehicle door during opening thereof, and accordingly one can dispense with corresponding pivoting of the mirror of the micro-mirror-unit for conforming the monitoring area to the degree of the opening of the door. This leads to a substantially simpler control and therewith to a substantially more robust door space monitoring device. By this selection of the position on or in the external mirror it becomes possible to design or construct the control of the at least one mirror in the micro-mirror-unit very simple to the extent that the one or more light beams are projected in the one planar monitoring area and, in particular, are pivoted in this planar monitoring or surveying area. Thereby it is ensured that together with the pivoting or swinging of the door the essentially two-dimensional surveying area, which is positionally fixed relative to the door, automatically swings over the pivot or swing area of the door, and a reliable surveying or monitoring of the door swing area is realized. In like manner, a suitable location for incorporation has been found to be the door handle of an automobile.

Besides this it has been found particularly useful to provide the light source, the micro-mirror-unit and the photo-receiver in the area of the pivot axis of the door, which again leads to a very simple control of the mirror through the control unit, since it is essentially only necessary that the pivot angle of the door be compensated by the corresponding pivoting of the micro-mechanical mirror. An elaborate compensation of substantial, noticeable displacements of the components of the sensor unit relative to the pivot axis need not be of concern, which substantially simplifies the control and therewith the design or construction of the sensor unit, and significantly ensures the functionality of the sensor device for the door area monitoring device. It has been found particularly advantageous to provide the components of the sensor unit on the vehicle door in the area of the pivot axis in an external mirror. In this case a particularly simple control of the mirror is made possible.

Beyond this it has been found particularly advantageous to provide the light source, the micro-mirror-unit, the photo-receiver and in certain cases the evaluation or as the case may be control unit in a common housing. Thereby it is accomplished that the optical relationship of the optical components of the sensor unit are mechanically continuously and reliably fixed. Thereby it is ensured, that even in the challenging conditions of a vehicle, which is subjected among other things to jolting, vibration, and impact, to realize a secure and long term reliable surveying of the door swing area. A misalignment of the individual components is substantially prevented by their placement in a common housing and therewith on a common mechanical basis and therewith in defined spatial relationship and orientation to each other. This results in a compact and reliable door area monitoring device.

Besides the possibility of using a laser light source or a light emitting diode as the light source, it has been found particularly advantageous to use an economical and robust PIN diode as photo-receiver. By this particular selection of the design of the monitoring area as two dimensional monitoring area it becomes possible to do without an expensive avalanche-photo-diode and to use a simple, robust and economical PIN-photo-diode as photo-receiver. Preferably those light sources and photo-receivers are employed, which in particular emit and, as the case may be, receive exclusively non-visible IR-emissions.

It has been found particularly advantageous to design the control unit in such a manner, that the light intensity of the light source is so selected, that the changes in the reflection relationship due to the pivoting of the micro-mechanical mirror of the micro-mirror-unit are compensated to the extent that the light beam reflected by the micro-mirror exhibits substantially the same light intensity, regardless of the degree of the tilt angle and therewith the magnitude of the pivoting of the micro-mechanical mirror. By this controlling of the light source it becomes possible to realize continuously a mirror-reflected light beam constant in its light intensity, and therewith having a defined emission, into the area being surveyed by the sensor unit, and a simple evaluation of the reflected beam received by the photo-receiver. This leads to a reliable indication of the presence of a obstacle in the area being monitored and therewith in the swing area of the vehicle door, without requiring elaborate and complicated provisions for differentiated evaluation need be met.

It has been found to be particularly advantageous to position the micro-mirror-unit between the light source and the photo-receiver, and to provide the control unit and/or the evaluation unit displaced sideways thereto. Thereby it becomes possible in particularly advantageous manner to bring close together the location of the light emission from, and the light entry into, the sensor unit, which makes possible a simplified and reliable evaluation. It has been found particularly useful to provide the control unit and the evaluation unit on a common circuit board, wherein the light source, the micro-mirror-unit and the photo-receiver are preferably provided in a common housing with the control and/or the evaluation device and mechanically rigidly connected with the housing. Therein it has been found particularly advantageous to secure the micro-mirror-unit, the light source and the photo-receiver to a common wall of the housing, which could be an outer wall of the housing or however also a wall within the outer wall of the housing. By this arrangement and securing to a common wall a very stable mechanical arrangement is created, which makes possible a very reliable emission of one or more light beams as well as the reception of the reflected light beams or the reflected light beam. Therein, this is ensured even under very difficult, in particularly vibration prone or strong jarring situations.

Beyond this it has been found particularly useful, to so design the sensor unit, that the light beam is pivoted over a predetermined angular range, in that by means of the control unit the at least one micro-mechanical mirror of the micro-mirror-unit is controlled to be pivoted accordingly. Therein the pivoting of the micro-mechanical mirror is so undertaken, that a two dimensional or a substantially two dimensional formation of the area being monitored, and a pivoting-through of the one or more light beams through the two dimensional area being monitored, is realized. By this design or embodiment of the sensor unit for the door area monitoring device it is accomplished, on the one hand, to do without high power light sources, since only one or few light beams of limited light intensity need be produced, without concern for a sufficient degree of reliability for the detection of obstacles in the area being monitored. Therewith it becomes possible to provide a simple and compact sensor unit which, with the aid of a simple control for pivoting of the one or few light beams in the two dimensional area being monitored, produces a reliable obstacle detection.

It has been found particularly advantageous to so design the control unit, that the pivoting-over of the predetermined pivot range, which preferably paints over or covers the entire door surface or a substantial part thereof, occurs within a time span TS of less than 5 ms. By the use of the micro-mechanical mirror in the micro-mirror-unit this rapid pivoting is realized, without requiring complex mechanical measures for ensuring guidance and mounting or bearing of the pivoting elements. This short pivot time provides the possibility, that the light source is only switched on and thus energized for this short pivot time, and for a subsequent long period of time is purposefully not in operation, and thus can be switched off. Preferably this time until the next pivoting is selected to be in the range of 25 ms or more. Thereby it is ensured, that the light source is not continuously in operation and therewith does not age or wear out as rapidly as if it were in continuous operation. Therewith a substantially longer lifetime of the light source and therewith a longer functionality of the inventive door area monitoring device is realized. Beyond this, by the pivoting in the short time span TS of approximately 5 ms or thereunder it is ensured that a penetration of a obstacle in the monitoring area is reliably detected even in the case of a rapid opening. This is not changed by the selection of the pause time up to the next active pivot or scan, and therewith monitoring in the range of greater than 25 ms, preferably less than 50 ms, does not change anything. It has been found particularly advantageous to select the relationship between monitoring and scanning and respective pivot time to pause time in the range of approximately 1 to 10. This leads to a reliable surveillance of the pivot area and to a long life of the door monitoring device.

In the alternative it has been found useful to so design the door area monitoring device, that the control unit controls or drives the light source and in particular the photo-receiver such that it is activated essentially only during the pivot process of the micro-mirror-unit, in particular only during each n-ten pivot process with n smaller than 10. For the remainder the light source or as the case may be photo-receiver are not activated. This leads on the one hand to a significantly reduced energy requirement and on the other hand to a reduced average beam power or output of the monitoring device or as the case may be light source, so that it becomes possible with one step to enter into a lower danger class, for example in laser class one, and thereby lesser or fewer supplemental constructive measures are necessary for protection of pedestrians. This results in a simpler constructed inventive monitoring device.

It has been found particularly advantageous to so arrange the light source or, as the case may be, the micro-mirror-unit or, as the case may be, the photo-receiver, such that the distance of the two dimensional area being monitored relative to the vehicle door increases with increasing distance from the pivot axis of the vehicle door. Thereby it is ensured, that an obstacle in the area of the greatest pivot speed of the vehicle door is detected already at a greater distance from the door and becomes recognized as an interfering obstacle, than an obstacle in an area with lesser pivot speed. Since these pivot speeds are directly correlated with the distance from the pivot axis of the door, it has been found particularly useful to select the distance of the two dimensional area being monitored to be particularly large there where the pivot speed of the door is particularly large, and therewith the distance from the pivot axis of the vehicle door is particularly large. By this arrangement or orientation of the components of the sensor unit, and therewith the design of the two dimensional monitoring area relative to the vehicle door, there is accomplished a very reliable observation or prediction regarding the collision danger potential of an obstacle in the area of the door, and therewith to prevent damaging of the door, for example by providing a warning signal and/or an automatic stop signal to prevent the further pivoting out of the door. Therewith a very secure and reliable door area monitoring device is provided.

It has been found particularly advantageous to design the sensor means such that a distance measurement between the sensor means and the object to be avoided takes place with use of a phase delay measuring process. By the use of a phase delay measurement process for determining the distance between the sensor means and the potential obstacle, it is accomplished that in contrast to the known phase delay measurement process the necessary optical transmission or radiation output can be selected to be smaller, without there resulting a degradation of the evaluation. Besides this, by the selection of the modulation, in particular by the selection of a broad band modulation, the influence of drift or temperature on the evaluation can be substantially reduced. By this inventive selection of the distance measuring process in the design of a phase delay process, there is accomplished a compact arrangement with reliable and very precise evaluation of the distance information, which makes it possible to evaluate whether a detected potential obstacle will or will not actually lie in the relevant door swing area.

This is preferably accomplished by comparison of the measured distance information with an image of the vehicle door stored preferably in the form of a look-up table. This stored image of the vehicle door is selected as reference value, and therewith as comparison dimension, for the measured distance, so that it can be recognized, for example, that an obstacle, which indicates a greater distance than the dimension (length) of the door in the concerned direction, cannot cause a collision with the vehicle door, and therewith is not interpreted as an actual obstacle. Besides the distance information, there is preferably taken into consideration a supplemental angular resolution in the two dimensional area being monitored, so that a reliable interpretation of distance information, in relationship to the shape or image of the vehicle door furnished as reference, can be made. By this special design of the distance measuring on the basis of a phase delay measurement in association with the comparison of the detected distances of potential obstacles from the sensor means relative to the shape or design of the door, it becomes possible to make a dependable prediction regarding an actual or expected colliding of the obstacle with the vehicle door. Therein it has been found particularly advantageous to design the two dimensional monitoring area to correspond to the contour of the vehicle door such that the distance from the door is either substantially constant or essentially increase with increasing distance from the pivot axis of the vehicle door. This leads to a particularly reliable distinction between actual and only apparent obstacles for the opening of the vehicle door.

If, as a result of carrying out the evaluation, the door space monitoring device recognizes an actual obstacle in the door swing area, then a warning signal is preferably emitted, which causes the vehicle operator to abstain from further opening of the door or, alternatively, a further automatic opening of the vehicle door is interrupted by appropriate control signals or a further opening of the vehicle door is actively prevented. By these precautions it is ensured that the door is not further opened when not desired, and that a damaging of the vehicle door and/or the obstacle does not occur.

### BRIEF DESCRIPTION OF THE DRAWINGS

In the following the invention will be described in greater detail on the basis of exemplary embodiments.

FIG. 1 shows a configuration of an exemplary sensor means, and

FIG. 2 shows an exemplary functional interrelation of the components of a door space monitoring device.

### DETAILED DESCRIPTION OF THE INVENTION

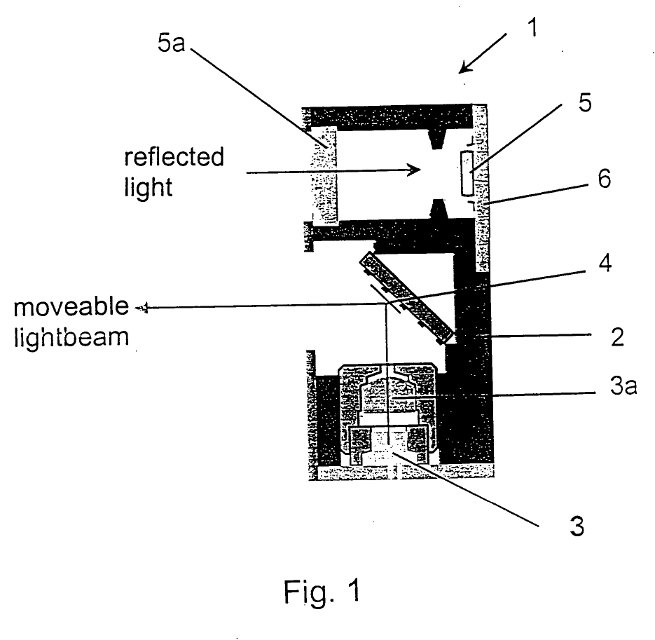

The sensor means 1 shown in FIG. 1 of the door space monitoring device includes a housing 2, in which the light source 3, which is a laser diode, a micro-mirror-unit 4 and a photo-detector 5 are provided. Therein the laser diode 3 is spatially separated from the photo-detector by the micro-mirror-unit 4.

The laser diode 3 is provided with a lens 3a, which acts as collimator for the light beam emitted by the laser diode. The light beam is cast upon the micro-mirror-unit 4. The micro-mirror-unit 4 includes a number of micro-mechanically driven micro-mirrors. These are controlled by a control unit provided on a circuit board 5 in such a manner, that the micro-mirrors can be pivoted, driven micro-mechanically. The pivoting is so controlled, that a pivoting light beam is emitted from the sensor means 1. The micro-mechanically driven micro-mirrors are provided upon a common carrier, which is in a rigid static connection with the housing 2 of the sensor means 1. The moved light beam is so moved via the pivotable micro-mirror, that it swings through a two dimensional monitoring area. The light beam is reflected from objects which penetrate into the monitored area or are located in this area, and this light is picked up by the photo-detector lens 5a and is bundled and collected on the photo-detector 5. The photo-detector 5 converts the reflected light into electrical signals, which are submitted to an evaluation unit provided on the circuit board 6. This evaluation unit determines, on the basis of the electrical signals supplied to it from the photo-detector 5, whether objects have or have not entered into the monitored area.

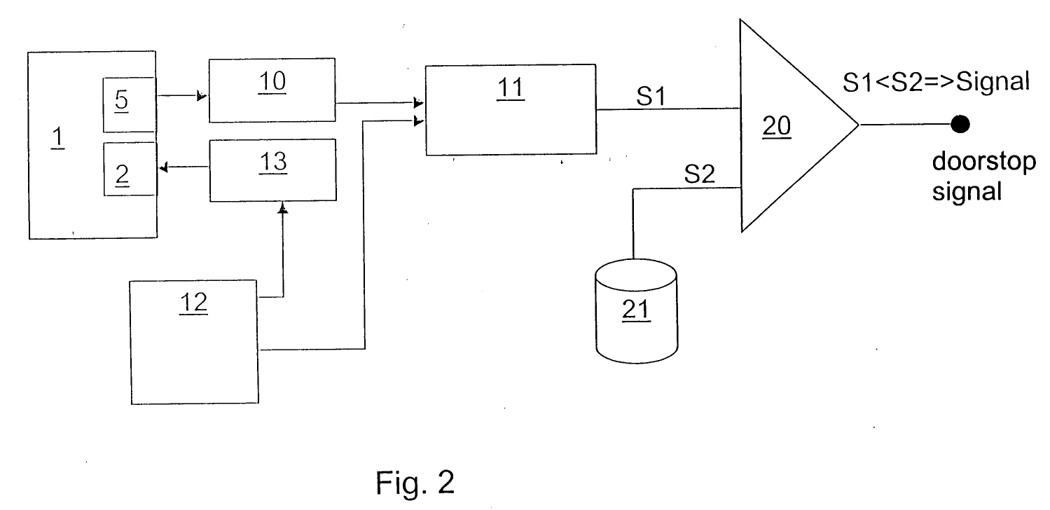

An illustrative functioning of the door space monitoring device is described in the following in greater detail on the basis of FIG. 2.

The electrical received signal supplied from the photo-detector 5, which represents the reflected received light, is supplied to an amplifier 10, which amplifies the electrical signal and therewith makes possible a phase delay measurement through the phase delay measurement unit 11 in particular measure or degree. The phase delay measurement unit 11 is supplied, in addition to the amplified received signal, also with a reference signal, which is generated by signal generator 12. This signal generator generates the modulation signal for the laser driver 13, which is associated with the laser light source 2. In recognition of the modulation of the light emitted by the laser source 2 and the modulation of the received light or as the case may be the reference signal, which is generated by the signal generator 12, or as the case may be the electrical received signal, it becomes possible to determine the length of the light path from the light source 2 to the object causing the reflection to the photo-diode 5, and therewith the distance S1 between the reflecting object (obstacle) to the sensor means. The distance S1 is compared with a reference distance S2. This comparison occurs in the comparator stage 20. If the distance S1 is smaller than the reference distance S2, which represents a value for a dimension of the vehicle door, then it is concluded therefrom, that this is an actual impediment or obstacle, and this could lead to a door stop signal. On the basis of this door stop signal an automatic door opening process is interrupted and therewith a further automatic opening, that is, a further pivoting of the door, is prevented. If the distance S1 is larger than the reference value S2, then it is concluded therefrom, that this is not a relevant obstacle which could lead to a damaging of the door, since it lies outside the swing coverage of the vehicle door.

In the memory 21 a large number of reference values S2 are stored in the form of a look-up table. The reference values S2 represent the shape of the vehicle door, wherein, beginning from the position of the sensor means, the length of the vehicle door corresponding to the two dimensional monitoring area, depending upon an elevation angle, is determined and stored. With the aid of the signal generator 12, which is part of the control unit of the sensor means 1, a pivoting of the micro-mirror of the micro-mirror-unit is caused to the extent that the emitted light beam is pivoted in the elevation angle of interest. If, during the emission of the modulated light signal through the light source 2, at a predetermined elevation angle a reflected light signal to be concerned with is received, which is submitted to the phase delay measuring unit 11 for distance determination, then the signal is evaluated and the distance S1 is determined. The distance S1 at the predetermined elevation angle during emission is compared with the reference distance S2 at that predetermined elevation angle from the lookup table, and it is therefrom deducted whether this is an actual obstacle.

By the suitable design of the micro-mirror-unit 4 an essentially two dimensional monitoring area is constructed, which exhibits a substantially constant distance to the vehicle door and which exhibits a comparable contour to the vehicle door. In the two dimensional monitoring area obstacles can be reliably detected by the door space monitoring device, and it can be determined on the basis of the distance measurement with the aid of a phase delay process whether the object is a relevant obstacle or not.

The sensor means 1 described in FIG. 1 makes possible, by the evaluation of the sensor means data according to FIG. 2, a very accurate and reliable identification of relevant obstacles, which could initiate a door stop signal. The door space monitoring device with sensor means 1 has proven itself to be very compact, robust and very reliable in its function.

1. A door space monitoring device for monitoring a door swing area of a vehicle door, with sensor means sensing in the door swing area, with a sensor-data evaluating evaluation unit and with a control unit for controlling the sensor means or evaluation unit, where the monitoring area sensed by the sensor means is substantially two-dimensional, that the sensor means includes at least one light source for emission of a pivotable light beam, at least one micro-mirror-unit and at least one photo-detector for monitoring the two-dimensional monitoring area.

2. The door space monitoring device according to claim 1, wherein the micro-mirror-unit with it's at least one micro-mechanical pivotable planar mirror is associated with an additional non-planar mirror.

3. The door space monitoring device according to claim 1, wherein that the additional non-planar mirror is shaped such that its contour corresponds to the contour of the vehicle door.

4. The door space monitoring device according to claim 2, wherein that the additional non-planar mirror is mounted to be pivotable and is preferably micro-mechanically driven.

5. The door space monitoring device according to claim 1, wherein the light source for emission of a pivotable light beam, the micro-mirror-unit and the photo-detector for detecting the two-dimensional monitoring area are provided on or in an external mirror which is attached to the vehicle door, or provided on or in a vehicle door handle.

6. The door space monitoring device according to claim 1, wherein the light source for emission of a pivotable light beam, the micro-mirror-unit and the photo-detector for detecting the two-dimensional monitoring area are provided in the area of the pivot axis of the vehicle door.

7. The door space monitoring device according to claim 1, wherein the light source for emission of a pivotable light beam, the micro-mirror-unit and the photo-detector for detecting the two-dimensional monitoring area are provided in a common housing.

8. The door space monitoring device according to claim 7, wherein within the housing the micro-mirror-unit is provided between the light source for emitting a pivotable light beam and the photo-detector, and that off-set to the side thereto, the control unit and/or the evaluation unit are provided preferably upon a common circuit board.

9. The door space monitoring device according to claim 1, wherein at least one photo-detector is a PIN-diode.

10. The door space monitoring device according to claim 1, wherein the control unit is so designed, that the light output of the light source controlled by the control unit is adjusted according to the degree of pivoting of the at least one micro-mechanical mirror of the micro-mirror-unit.

11. The door space monitoring device according to claim 1, wherein the control unit is so designed, that the pivoting of the at least one micro-mechanical mirror of the micro-mirror-unit is controlled by the control unit to pivot at regular intervals over a predetermined pivot range to produce a light beam passing through the two-dimensional monitoring area.

12. The door space monitoring device according to claim 11, wherein the control unit is so designed, that a pivoting over a predetermined pivot range occurs within a time span TS of less than 5 ms.

13. The door space monitoring device according to claim 12, wherein the control unit is so designed, that between two pivot processes a time span TP of greater than 25 ms and preferably less than 50 ms occurs.

14. The door space monitoring device according to claim 12 wherein the control unit is so designed, that the light source and preferably also the photo-detector are activated essentially only during the pivot process, preferably only during each n-ten pivot process with n being less than 10.

15. The door space monitoring device according to claim 1, wherein the light source for emitting a pivotable light beam, the micro-mirror-unit and the photo-detector for detecting the two dimensional monitoring area are so arranged, that the distance of the two dimensional monitoring area from the vehicle door essentially also increases with increasing distance of the two dimensional monitoring area from the pivot axis of the vehicle door.

16. The door space monitoring device according to claim 1, wherein the light source for emitting a pivotable light beam, the micro-mirror-unit and the photo-detector for detecting the two dimensional monitoring area are provided in a common housing together with the evaluation unit for distance measurement by means of a phase delay process.

17. The door space monitoring device according to claim 16, wherein the evaluation unit is adapted to carry out on the basis of reference values, preferably a lookup table stored in memory, corresponding to the shape or design of the vehicle door, an evaluation of relevance for potential detected obstacles.

18. The door space monitoring device according to claim 1, wherein dependent upon the detection of an obstacle in the door swing area a warning signal is emitted, a further automatic opening of the vehicle door is interrupted, or a further opening of the vehicle door is actively prevented.
